(19) United States
(12) Patent Application Publication
(10) Pub. No.: US 2023/0137289 A1
(43) Pub. Date: May 4, 2023

(54) Bed Comprising a Foldable Board and a Foldable Mattress

(71) Applicant: M/S LIFELINE PHARMA, Mumbai (IN)

(72) Inventor: Prasad Narayan Nakhare, Mumbai (IN)

(21) Appl. No.: 17/909,528

(22) PCT Filed: Mar. 4, 2021
(86) PCT No.: PCT/IN2021/050211

§ 371 Date: Sep. 6, 2022

(30) Foreign Application Priority Data
Mar. 4, 2020 (IN) 202021009331

(51) Int. Cl. A61G 7/10

(52) U.S. Cl. CPC A61G 7/103; A61G 7/1034; A61G 7/1026

(57) ABSTRACT

A bed including a foldable board and a foldable mattress wherein such that each foldable board and foldable mattress have equal number of foldable parts symmetrically and correspondingly hinged together, each foldable board having roller assemblies embedded in its bottom surface. The said roller assemblies being aligned to each other the mattress includes of foldable side supports and foldable head supports the locking belts securely hold together the bed to the cot or the stretcher.

### CROSS REFERENCE TO RELATED APPLICATIONS

This application is the United States national phase of International Application No. PCT/IN2021/050211 filed Mar. 4, 2021, and claims priority to Indian Patent Application No 20201009331 filed Mar. 4, 2020, the disclosures of which are hereby incorporated by reference in their entirety.

### BACKGROUND OF THE INVENTION

### Field of Invention

The invention relates to unique type of device for transferring an ailing patient from stretcher to cot, cot to cot or cot to stretcher. The said device is most suitable for critical patients, unconscious patients, comatose patients, patients critically injured in an accident and patients in ICU/ICCU. The said device enables ease of transferring the patient.

### Description of Related Art

Generally, transferring an ailing patient requires a huge amount of physical labour in addition to the utmost care that needs to be taken for the safe transfer. In some cases, patients have to be transferred without any change in their postures, in which case the available devices aren't appropriate.

In order to solve these problems, there is a need for a new patient transfer device that can transfer patients in a seamless manner with the least amount of discomfort.

In Chinese Patent No. CN109771151 hereinafter referred as “DAI HONGPING”, a surgical patient transfer bed is described that includes a bed body and protective plates which are characterized in that: two sides of the bed body are respectively equipped with moving rails; the bottom of the protective plate is provided with a movable cylinder slidingly matched with the moving rail. The protective plates are adjustable so as to avoid slippage of the patient. However, this device fails to address the issue of seamless transfer of the patient from bed to stretcher or stretcher to bed as the patient has to be lifted during the said transfer causing discomfort to the patient.

In Chinese Patent No CN103494677 hereinafter referred as “GAN WEIMIN”, the transfer bed is divided into 3 frames, namely lower frame, intermediate frame and upper frame. There is a lifting mechanism provided between the lower frame and middle frame. There is a turning mechanism provided between the intermediate and upper frame which enables the sliding of plurality of mutually independent sliding palates which are pushed one by one under the patient bed using a hand wheel. While sliding them under the patient, the patient is lifted slightly by the mechanism. To transfer the patient, the hand wheel has to be rotated in opposite direction and the synchronous pull rod is used to move the sliding pallets thereby shifting the patient. This device is however very bulky and in addition has a complicated system of transferring the patient.

U.S. Pat. No. 2,630,583 hereinafter referred to as “Gilleland” provides a stretcher comprising a substantially horizontal deck portion, provided with rollers, an apron, a mobile patient supporting member, a prime mover and power transmitting means and an electric motor. However, transferring the patient using this device from the patient bed to the stretcher involves turning the patient with his/her back to the stretcher so that the said apron can be slided underneath using the electric motor thereby enabling the patient to be moved onto the stretcher. This in turn poses a huge disadvantage of harming the patient; hence this device doesn't give a practical solution of smooth patient transfer.

U.S. Pat. No. 3,854,152 hereinafter referred to as “CHEZ”, provides an apparatus for transferring patients which includes a transferring device comprising two tracks or conveyors, said conveyors encircle plurality of rollers which are connected to a driving gear through an endless chain. The conveyors can be moved using a crank handle or a drive handle thereby positioning the lower track under the patient and then sliding the patient onto the said transferring device. However, this invention involves use of electric motor to drive the conveyors and it is bulky with two conveyors hence it cannot facilitate easy movement of patient from one place to another.

U.S. Pat. No. 6,349,432 B1 hereinafter referred to as “Scordato”, provides a method and apparatus for patient transfer, the method involves providing a low friction surface over any significant portion of a bed or other platform over which the person is to be moved, the person being mounted on a low friction board or sheet having straps extending therefrom to facilitate movement of the person acrossa first platform to a second platform. The invention includes low friction transfer boards, low friction sheets and special straps adapted for practicing the said method. However, since this method and apparatus involves a low friction surface which needs to be inserted below the patient, it causes discomfort to a patient, the patient must be turned sideways for the above to be performed and is not suitable for patients with injuries that restrict them from turning sideways.

U.S. Pat. No. 5,860,174 hereinafter referred to as “Failor”, provides a patient transfer mattress system including a bottom mattress section and a top, transfer mattress section. The transfer mattress section includes lateral flaps which are coupled to the sides of the bottom mattress section by hook and loop type fasteners. The interface of the top and bottom mattress sections is low friction. The bottom mattress is said to include an encasing cover, the bottom surface of the said cover is said to be substantially slippery. Failor also discloses the use of multi layer static dissipative fluropolymer film with PTFE surface to facilitate the above function. Velcro is used to fasten the top mattress section to the bottom mattress section. However the above invention does not disclose a means for securing/nestling the patient into the mattress to safely transfer the patient from cot to stretcher or stretcher to cot or other surface.

None of the above prior art documents disclose a device that allows ease of transferring the patient without complicated parts and/or an electrical means and/or without the need for low friction surfaces which require the patient to be turned for the device to be inserted.

It is desirable to have a transferring device that has a simple assembly with convenience and comfort of the patient kept on the highest pedestal.

It is also desirable to have a transferring device that nestles the patient safely within the device during the transfer process and thereafter adapts to a standard sized stretcher or cot.

It is also desirable to have a transferring device that is portable and can be folded or collapsed to consume minimum space when not in use and can be stored in a vehicle/ambulance and unfolded when required.

It is further desirable to have an assembly structured such that it allows ease of maintenance and replacement of parts while still maintaining optimum efficiency of the transferring process.

### SUMMARY OF INVENTION

A bed comprising a foldable board and a foldable mattress characterized such that each foldable board and foldable mattress have equal number of foldable parts symmetrically and correspondingly hinged together, each foldable board part having roller assemblies embedded in its bottom surface, the said roller assemblies being aligned to each other

Typically, a bed comprising a foldable board and a foldable mattress wherein the board and the mattress comprise of four or more foldable parts

Typically, a bed comprising a foldable board and a foldable mattress wherein the mattress comprises of foldable side supports

Typically, a bed comprising a foldable board and a foldable mattress wherein the mattress comprises of foldable head supports

Typically, a bed comprising a foldable board and a foldable mattress wherein safety belts are provided on the board or on the mattress to securely hold the foldable side supports and foldable head supports in their folded position

Typically, a bed comprising a foldable board and a foldable mattress wherein the foldable side supports and foldable head supports of the mattress can be fixed in their folded position by fasteners

Typically, a bed comprising a foldable board and a foldable mattress wherein mattress belts securely hold together the mattress and the board

Typically, a bed comprising a foldable board and a foldable mattress wherein the locking belts securely hold together the bed to the cot or the stretcher

### BRIEF DESCRIPTION OF DRAWINGS

FIG. 1 shows the bottom view of the board 100, bottom of the roller assembly 200, board parts 101a, 101b, 101c, and 101d; hinges 102, slits 103, 104, 105, and 106; flexible handles 104a and locking belt 106a

FIG. 2 shows the top view of the board 100, top of the roller assembly 200, board parts 101a, 101b, 101c, and 101d; hinges 102, slits 103, 104, 105, and 106; flexible handles 104a and locking belt 106a.

FIG. 2a shows the isometric view of the board 100 in an unfolded/open position. FIG. 2b shows the isometric view of the board 100 in a folded position.

FIG. 3a shows the top view of the roller assembly showing the bracket 201 and bolt with nut 205.

FIG. 3b shows a sectional view of the roller assembly from the front and rear of the board 100 showing the bracket 201, Pin 202, bearing 203, roller 204 and bolt with nut 205.

FIG. 3c shows another sectional view of the roller assembly from the sides of the board 100 showing the bracket 201, Pin 202, bearing 203 and roller 204.

FIG. 4 shows an isometric view and a preferred embodiment of the board 100 along with the mattress 300 and stretcher 400 showing slit 103, slit 104, slit 105, slit 106, mattress belt 103a, flexible handles 104a, safety belt 105a, locking belt 106a.

FIG. 4a shows an isometric view of the mattress 300 showing foldable base parts 301a, 301b, 301c and 301d, in an unfolded position; foldable side supports 302a, 302b, 302c and 302d, in a folded position; foldable head supports 303a, 303b and 303c, in a folded position; and safety belt 105a.

FIG. 4b shows an isometric view of the mattress 300 showing foldable base parts 301a, 301b, 301c and 301d, in an unfolded position; foldable side supports 302a, 302b, 302c and 302d, in a unfolded position; foldable head supports 303a, 303b and 303c, in a unfolded position; and safety belt 105a.

FIG. 4c shows an isometric view of the mattress 300 in a lengthwise folded position by the foldable base parts 301a, 301b, 301c and 301d which allows the base of the mattress 300 to be folded, thereby reducing its length for storage; foldable side supports 302a, 302b, 302c and 302d are shown in an unfolded position; foldable head supports 303a, 303b and 303c are shown in an unfolded position; and safety belt 105a can be seen.

FIGS. 5a, 5b and 5c show an isometric view of a working example of the present invention where in the board 100 is preferably embodied under the mattress 300.

### DESCRIPTION OF THE INVENTION

The present invention will now be described with reference to the accompanying drawings wherein the same numerals are used to denote the same part. However, the drawings only illustrate the invention and in no way limit the invention.

The terms and words used in the following description and claims are not limited to the bibliographical meanings, but, are merely used by the inventor to enable a clear and consistent understanding of the invention. The description given hereinbelow is only representative of the illustrative embodiments and examples. Only for the sake of convenience, the description has focused on a limited number of representative examples of the drawings. However, the drawings and/or illustrations and/or the appended claims in no way limit the scope of the invention. It is understood that modifications and/or alterations of the drawings/illustrations of this invention other than those specifically set forth herein may be achieved by those skilled in the art and that such modifications and alterations are to be considered as falling within the overall scope of this invention.

### REFERRING TO THE DRAWINGS

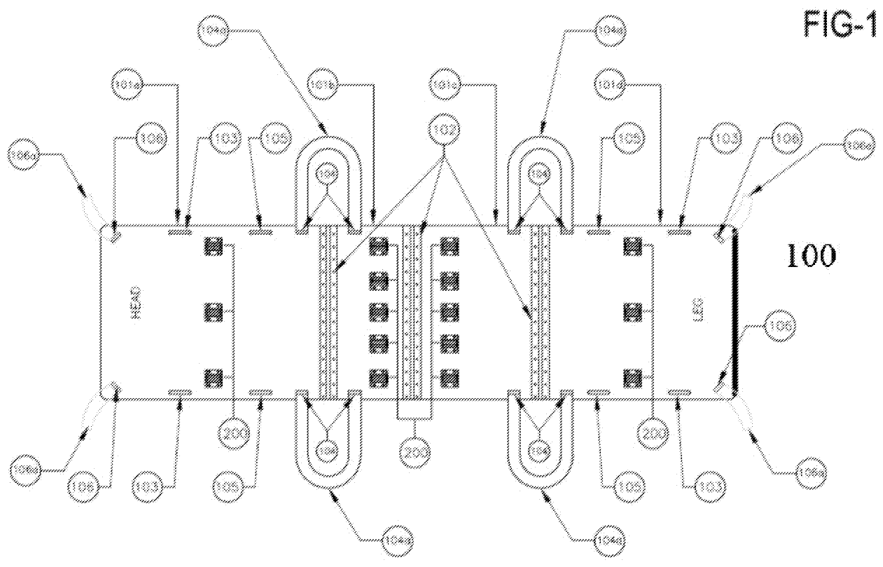

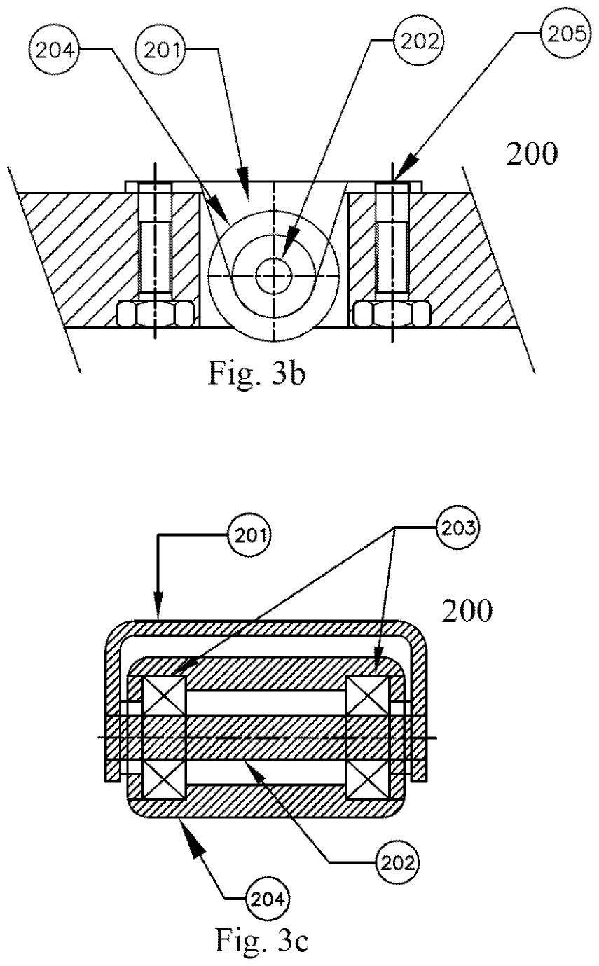

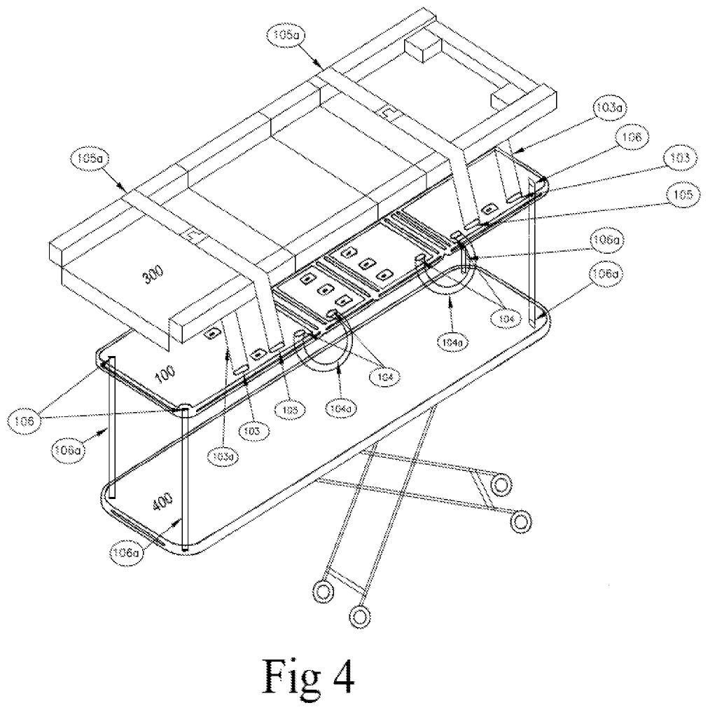

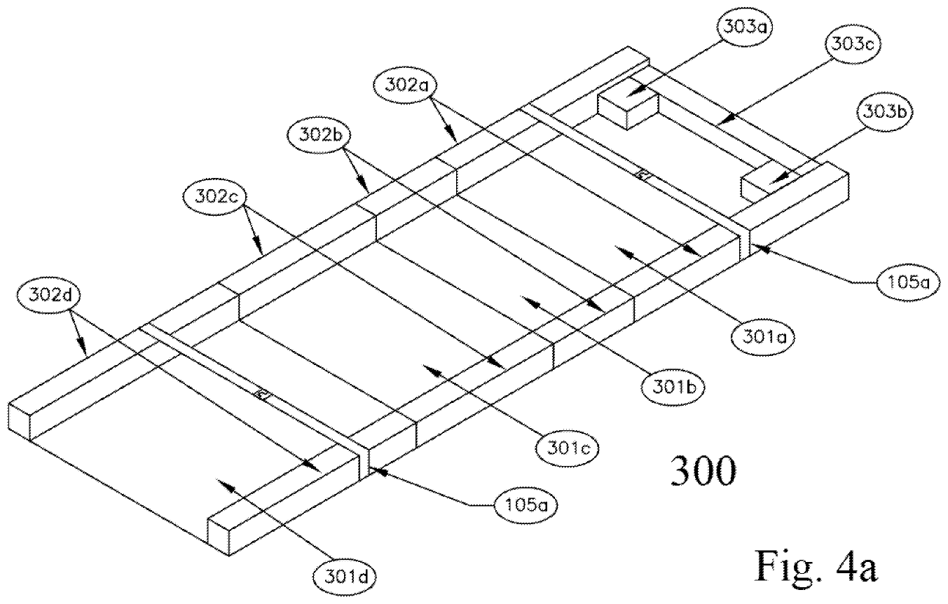

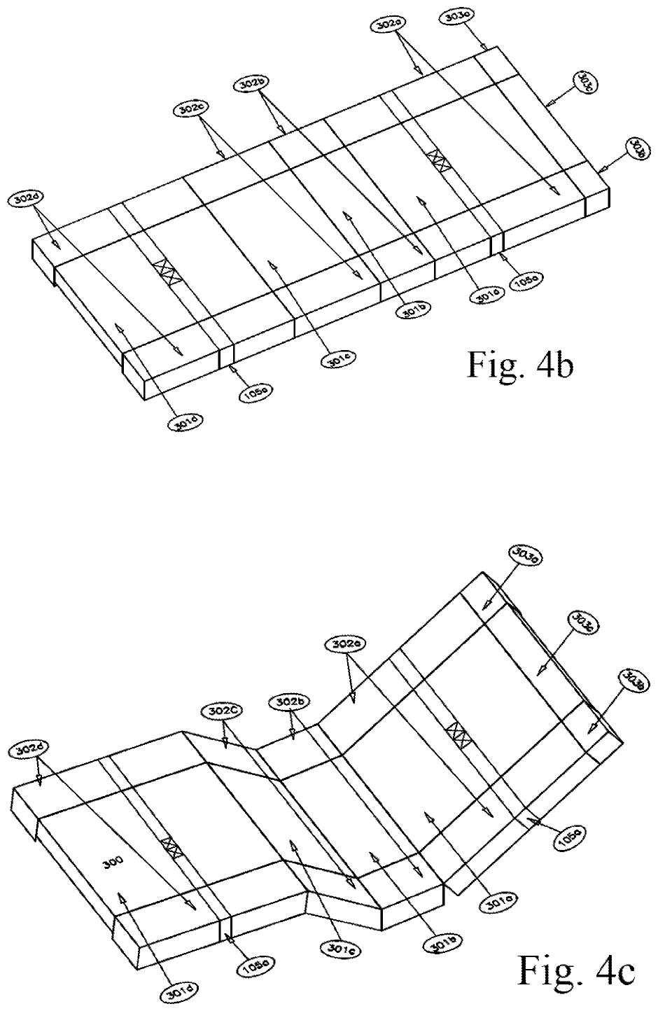

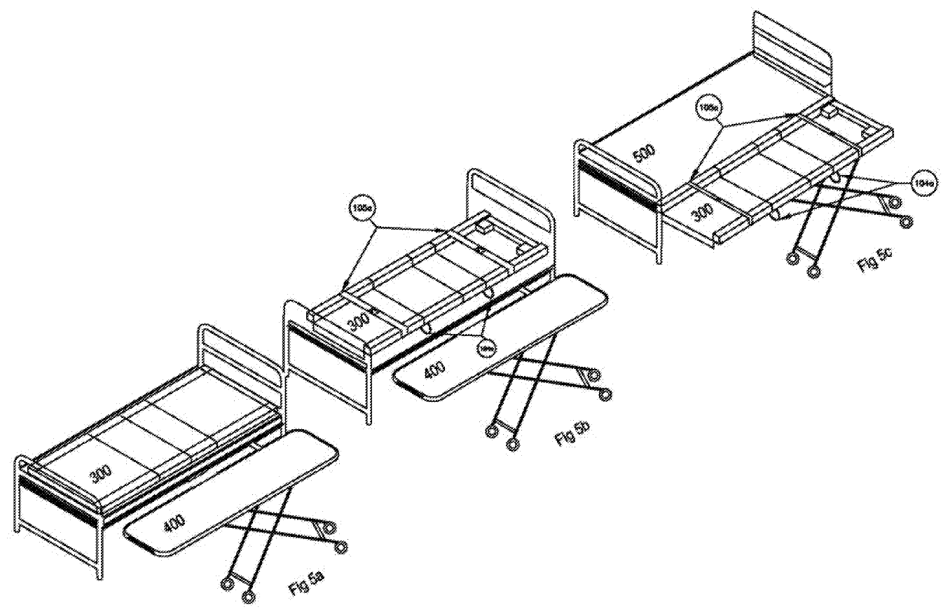

In a preferred embodiment of the present invention, the board (100) shown in FIG. 1 shows the four board parts 101a, 101b, 101c and 101d hingedly joined together by hinges 102 to form the board 100. Each board has a plurality of roller assemblies 200. In a preferable embodiment of the present invention, the board 100 shown in FIG. 1 comprises of roller assemblies 200 consisting of a bracket 201 housing a pin 202, bearings 203 and roller 204. The roller 204 rotates along the axis of the pin 202 as shown in FIGS. 3a and 3b. The roller assemblies 200 are fitted on to the boards by bolts and nuts 205 as shown in FIGS. 3a and 3b for allowing the board to preferably roll laterally. Three such roller assemblies 200 are fitted on the patient's leg side board part 101d and three roller assemblies 200 are fitted on the patient's head side board part 101a. Five roller assemblies 200 each are fitted at the patient's back and thigh side board respectively. The preferred embodiment of the present invention comprises of a washable mattress 300 as shown in FIGS. 4 and 4a which is fixed to the board (100) with the help of four mattress belts 103a that go through the slits 103 on the head side board part 101a and leg side board part 101d as shown in FIG. 4. The mattress 300 is made detachable from the board 100 to wash and sanitize the mattress 300 and also easily service the mechanical parts of the board 100 whenever required. The board 100 and mattress 300 together form the present invention and take the shape of a standard patient cot 500 as shown in FIGS. 5a, 5b and 5c. The board 100 has flexible handles 104a which are attached to the board 100 by slits 104 as well as safety belts 105a which are attached to the board 100 by slits 105 as shown in FIGS. 4, 5a, 5b and 5c as shown in FIG. 4. The present invention can be comfortably worked by a single person by pulling the flexible handles 104a with both hands. The length of the flexible handles 104a have been sized such that distance between the person working the present invention and the patient's cot 500 is comfortably and adequately met to pull the present invention along with the attached mattress 300 and patient safely secured therein onto the stretcher 400 as shown in FIGS. 5a, 5b and 5c.

The mattress 300 can be adapted to the size of the stretcher 400 as shown in FIG. 4 and FIG. 5c and the size of the cot 500 as shown in FIG. 5a. The board 100 along with the mattress 300 can be fixed and locked on to the patient cot 500 with the help of four locking belts 106a that go through the slits 106 on the head side board part 101a and leg side board part 101d as shown in FIG. 4. The mattress 300 as shown in FIG. 4a has a plurality of foldable parts. The preferred embodiment of the present invention consists of a mattress 300 which as a whole comprises of three sets of foldable parts that are hingedly joined together. The three sets of foldable parts are (i) foldable base parts 301a, 301b, 301c, 301d forming the base of the mattress, (ii) foldable side supports 302a, 302b, 302c and 302d; and (iii) foldable head supports 303a, 303b and 303c. The foldable side supports and foldable head supports are hingedly joined such that they can be upwardly folded and secured in place by the safety belt 105a. Alternatively fasteners may be used to fix the foldable side supports and foldable head supports in their folded position. FIGS. 5a, 5b and 5c show a working example of the present invention wherein the board 100 (not seen) is fixed under the mattress 300. When the patient is on the cot 500 the three sets of foldable parts as mentioned above are in an unfolded position and adapt to the size of the patient cot 500. While being transferred a patient can be nestled within the mattress 300, the foldable parts are secured in the folded position by the safety belt 105 as shown in FIGS. 4a and 5b. The foldable side supports and foldable head supports are used for supporting and securing the patient while being transferred from the stretcher 400 to cot 500 as shown in 4 and FIG. 5c. The present invention can also be used to safely and efficiently transfer the patient from a patient cot 500 to patient cot 500, stretcher 400 to patient cot 500 and stretcher 400 to stretcher 400. The judicious combination of the board 100 and mattress 300 work together in synergy to safely and efficiently transfer the patient as described above.

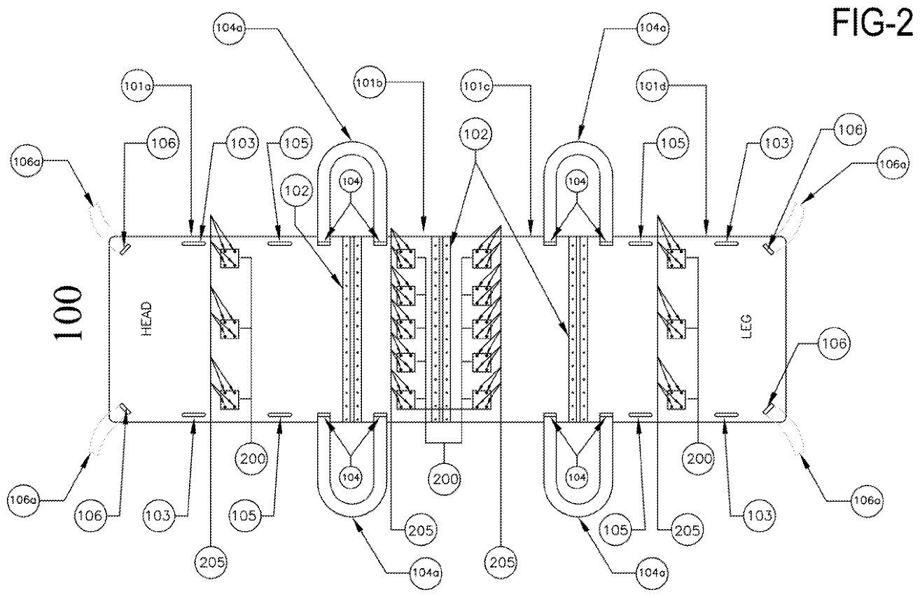

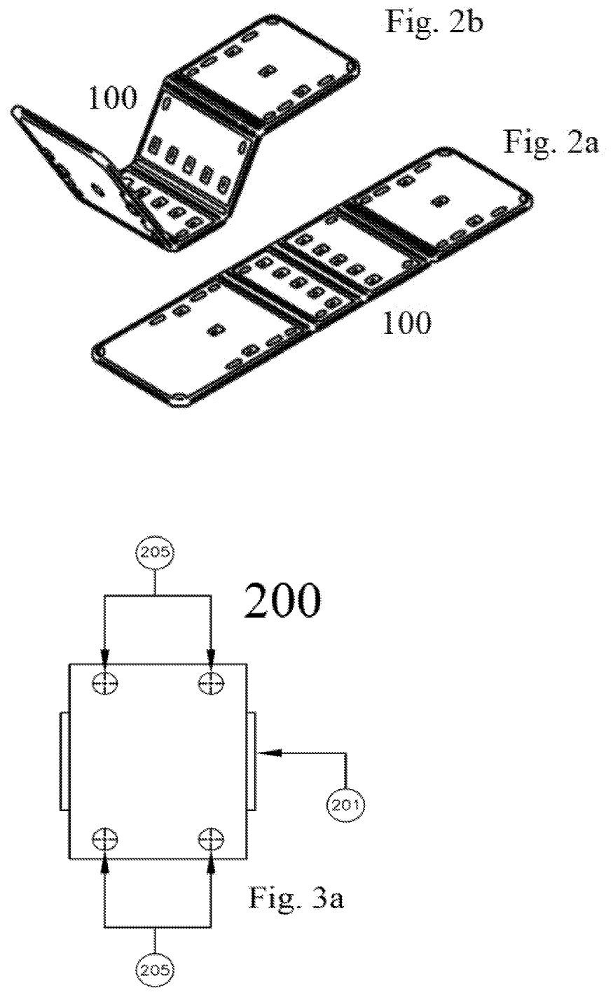

In the preferred embodiment of the present invention the board 100 is made to be foldable as shown in FIGS. 2a and 2b so that it will take minimum space to store when it is not in use. Similarly in the preferred embodiment of the present invention the mattress 300 is also made foldable lengthwise by the foldable base parts 301a, 301b, 301c and 301d as shown in FIG. 4c.

Advantages of Present Invention:
1. Enables smooth transfer of patient from stretcher to cot, cot to cot and cot to stretcher.
2. Requires minimum storage space when not in use.
3. Device does not require electricity and is completely maintenance free.

### EXAMPLES

1. In a preferable embodiment of the present invention it is placed between the mattress and patient cot, the patient can be easily transferred from the cot to a stretcher, stretcher to a cot and cot to cot.
2. In another embodiment of the present invention and the mattress are both folded and placed in an ambulance, when an emergency arises the present invention and the mattress are both unfolded the mattress is fixed onto the present invention, the patient is placed on it. The patient can then be lifted from the floor with the help of the flexible handles and placed into the ambulance or onto a stretcher and then smoothly transferred as required.
3. In another embodiment of the present invention the mattress and the board are non-detachable, they are permanently fixed together to form the present invention.
4. In another embodiment of the present invention the mattress and the board together roll as per the alignment of the rolling assemblies.

1. A bed comprising a foldable board and a foldable mattress each foldable board having foldable parts hinged together and each foldable mattress having equal number of foldable parts hinged together, the foldable parts and are symmetrical and corresponding to each other, each foldable board has roller assemblies embedded in its bottom surface, the said roller assemblies being aligned to each other.

2. The bed as claimed in claim 1, wherein the board and the mattress comprise four or more foldable parts.

3. The bed as claimed in claim 1, wherein the mattress comprises foldable side supports.

4. The bed as claimed in claim 1, wherein the mattress comprises foldable head supports.

5. The bed as claimed in claim 1, wherein safely belts are provided on the board or on the mattress to securely hold the foldable side supports and foldable head supports in their folded positions.

6. The bed as claimed in claim 1, wherein the foldable side supports and foldable head supports of the mattress can be fixed in their folded position by fasteners.

7. The bed claimed in claim 1, wherein mattress belts securely hold together the mattress and the board.

8. The bed as claimed in claim 1, wherein locking belts securely hold together the bed to a cot or a stretcher.
